(19) United States
(12) Patent Application Publication
(10) Pub. No.: US 2021/0324954 A1
(43) Pub. Date: Oct. 21, 2021

(54) TRANSMISSION CONTROL DEVICE AND TRANSMISSION CONTROL METHOD FOR CONTINUOUSLY VARIABLE TRANSMISSION

(71) Applicant: JATCO LTD, Fuij-shi, Shizuoka (JP)

(72) Inventors: Jaeseok LIM, Seoul (KR); Wonjoon CHUNG, Atsugi, Kanagawa (JP); Youngkwang KIM, Seoul (KR); Sungyub HAN, Seoul (KR)

(21) Appl. No.: 16/467,584

(22) PCT Filed: Dec. 11, 2017
(86) PCT No.: PCT/JP2017/044263

§ 371 Date: Jun. 7, 2019

(30) Foreign Application Priority Data
Dec. 12, 2016 (JP) 2016-240203

(51) Int. Cl. F16H 61/662; F16H 59/18; F16H 59/44; F16H 59/48

(52) U.S. Cl. CPC F16H 61/662; F16H 59/18; F16H 2061/6615; F16H 59/48; F16H 59/44

(57) ABSTRACT

A transmission control device of a continuously variable transmission provided in a vehicle includes a continuously variable transmission and a transmission controller. When the pseudo stepped transmission mode is selected, the transmission controller is configured to perform pseudo stepped upshift which repeats a transmission ratio suppression phase in which changes in the transmission ratio of the continuously variable transmission are suppressed, and an upshift phase in which the transmission ratio of the continuously variable transmission is upshifted. When performing the pseudo stepped upshift, the transmission controller is configured to determine an acceleration intention based on an accelerator opening degree and a vehicle speed, and to set upshift time required to pass through the upshift phase so that the larger the acceleration intention, the shorter the upshift time, and so that, for the same accelerator opening degree, the higher the vehicle speed, the shorter the upshift time.

### CROSS-REFERENCE TO RELATED APPLICATIONS

This is a U.S. national phase application of PCT/JP2017/044263, filed on Dec. 11, 2017, which claims priority to Japanese Patent Application No. 2016-240203, filed on Dec. 12, 2016. The entire disclosure of Japanese Patent Application No. 2016-240203 is hereby incorporated herein by reference.

### TECHNICAL FIELD

The present invention relates to a transmission control device and a transmission control method of a continuously variable transmission having as transmission modes a continuously variable transmission mode and a pseudo stepped upshift mode.

### BACKGROUND ART

Conventionally, in continuously variable transmissions, known are transmission control devices of a continuously variable transmission for performing a pseudo stepped upshift (transmission that repeats a transmission ratio suppression phase and an upshift phase) which is a transmission control such as stepped transmission. This pseudo stepped upshift is transmission performed when there is acceleration intention by the driver, and by executing the pseudo stepped upshift, gives the driver an acceleration feeling (see Japanese Laid-Open Patent Publication No. 2010-007749, for example).

However, the pseudo stepped upshift of the prior art still had room for improvement with regards to the points noted below.

The greater the acceleration intention of the driver, the better the acceleration feeling that is desired, and when the acceleration intention is large, it is desirable to set the upshift time, which is the time when the drive force is released, to be short. On the other hand, with the pseudo stepped upshift of the prior art, the upshift time has a fixed value regardless of the size of the acceleration intention, so it is not possible to realize an acceleration feeling in accordance with the acceleration intention. For example, when the upshift time suitable for when the acceleration intention is small is set as a fixed value, this unsuitable for when the acceleration intention is large. There was also the problem that, when the upshift time suitable for when the acceleration intention is large is set as a fixed value, this is unsuitable for when the acceleration intention is small.

### SUMMARY

The present invention was created with a focus on the problems noted above, and its purpose is to obtain an acceleration feeling suitable for the acceleration intention of the driver when performing pseudo stepped upshift.

To achieve the purpose noted above, the present invention comprises: a continuously variable transmission arranged between a travel drive source and drive wheels; and a transmission control means.

When pseudo stepped transmission start condition is not established, the transmission control means selects a continuously variable transmission mode that continuously changes a transmission ratio of the continuously variable transmission, and when the pseudo stepped transmission start condition is established, selects a pseudo stepped transmission mode that changes the transmission ratio of the continuously variable transmission in steps, simulating stepped transmission.

In this vehicle, when the pseudo stepped transmission mode is selected, the transmission control means performs pseudo stepped upshift which repeats a transmission ratio suppression phase in which changes in the transmission ratio of the continuously variable transmission are suppressed, and an upshift phase in which the transmission ratio of the continuously variable transmission is upshifted.

When performing the pseudo stepped upshift, the larger the acceleration intention, the shorter the upshift time needed to pass through the upshift phase is set to be.

Specifically, the transmission ratio suppression phase of the pseudo stepped upshift is a phase in which the transmission input rotation speed (drive source rotation speed for travelling) rises according to a rise in the transmission output rotation speed (vehicle speed), sharing the function for ensuring driving force. Meanwhile, the upshift phase of the pseudo stepped upshift is a phase in which the transmission input rotation speed (drive source rotation speed for travelling) decreases with respect to a rise in the transmission output rotation speed (vehicle speed), sharing the function for releasing the driving force.

Focusing on this point, when performing the pseudo stepped upshift, the larger the acceleration intention of the driver, the shorter the upshift time required for passing through the upshift phase is set, and by doing this, the upshift time, which is the time the driving force is released, is dependent on the size of the acceleration intention.

In this way, by setting the upshift time, which is the release time of the driving force, according to the size of the acceleration intention of the driver, it is possible to obtain an acceleration sense suited to the acceleration intention of the driver when performing pseudo stepped upshift.

### BRIEF DESCRIPTION OF THE DRAWINGS

FIG. 1 is an overall system drawing showing the drive system and control system of an engine vehicle to which the transmission control device and transmission control method of a continuously variable transmission of embodiment 1 are applied.

FIG. 2 is a transmission schedule drawing showing an overview of the transmission schedule used when executing transmission control using a variator mounted in the drive system of the engine vehicle.

FIG. 3 is a flow chart showing the flow of a transmission control process executed by a CVT control unit of embodiment 1.

FIG. 4 is a flow chart showing the flow of the required information acquisition process for determining the pseudo stepped upshift characteristic line by repetition of a transmission ratio suppression phase line and an upshift phase line when the pseudo stepped upshift mode is selected in the transmission control process of embodiment 1.

FIG. 5 is a time chart showing an example of an upshift judgment map and an upshift map for setting an upshift start rotation speed A(x) and an upshift end rotation speed B(x) according to the size of the accelerator opening APO in the pseudo stepped upshift.

FIG. 6 is an upshift time map diagram showing an example of an upshift time map for setting upshift time T1(x) according to the size of the accelerator opening APO and the height of the vehicle speed VSP in pseudo stepped upshift.

FIG. 7 is an upshift timing map diagram showing an example of an upshift timing map for setting upshift timing T2(x) according to the height of a transmission ratio i and the height of the vehicle speed VSP in the pseudo stepped upshift.

FIG. 8 is a time chart showing an example of a pseudo stepped upshift characteristic line for explaining the transmission control operation by changing of the upshift time T1(x).

FIG. 9 is a time chart showing the vehicle speed rise characteristics when accelerating while keeping an accelerator opening APO of opening degree 8/8.

FIG. 10 is a time chart showing an example of a pseudo stepped upshift characteristic line for explaining the transmission control operation by changing of the upshift timing T2(x).

FIG. 11 is a heat generation amount explanatory diagram showing a comparison of the unit heat generation amount according to the pseudo stepped upshift characteristic line with a comparison example in which the upshift timing is constant and the pseudo stepped upshift characteristic line of embodiment 1 in which the upshift timing T2(x) is changed.

FIG. 12 is an operation explanatory diagram showing an example of the pseudo stepped upshift characteristic line when the accelerator depression operation is performed midway during execution of pseudo stepped upshift.

FIG. 13 is an upshift time map diagram showing another example of the upshift time map for setting the upshift time T1(x) according to the size of the accelerator opening APO and the height of the vehicle speed VSP in pseudo stepped upshift.

FIG. 14 is an upshift timing map diagram showing another example of an upshift timing map for setting the upshift timing T2(x) according to the height of the transmission ratio i and the vehicle speed VSP in pseudo stepped upshift.

### DETAILED DESCRIPTION OF EMBODIMENTS

Hereafter, a preferred mode for realizing the transmission control device and the transmission control method of a continuously variable transmission of the present invention is explained based on embodiment 1 shown in the drawing.

Embodiment 1

First, the configuration is explained.

The transmission control device and transmission control method of embodiment 1 are applied to an engine vehicle in which is mounted a belt type continuously variable transmission called a variator as the continuously variable transmission. Hereafter, the configuration of embodiment 1 is explained divided into the “Overall System Configuration,” the “Transmission Control Configuration,” the “Transmission Control Process Configuration,” and the “Required Information Acquisition Process Configuration with Pseudo Stepped Upshift.”

### Overall System Configuration

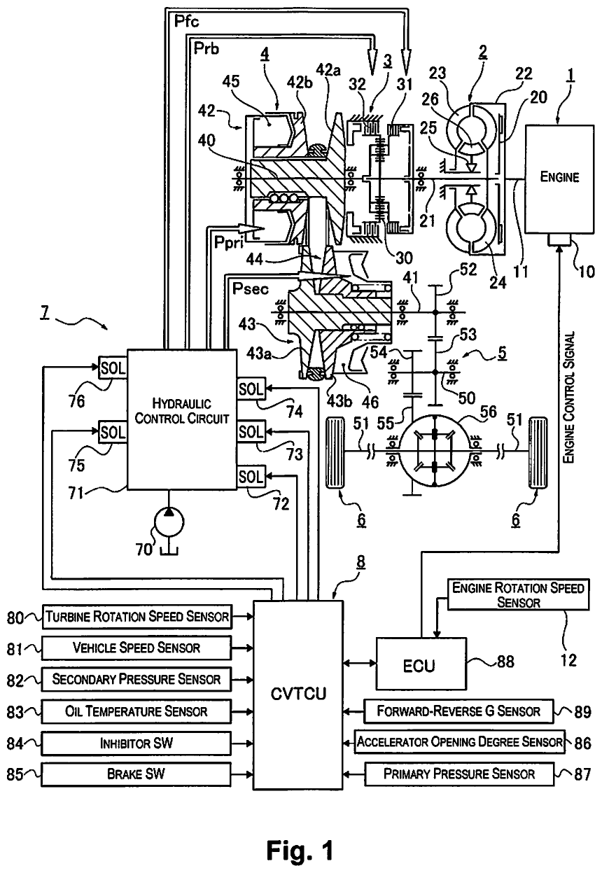

FIG. 1 shows a drive system and a control system of an engine vehicle to which are applied the transmission control device and the transmission control method of the continuously variable transmission of embodiment 1. Following, the overall system configuration is explained based on FIG. 1.

As shown in FIG. 1, the drive system of the engine vehicle is provided with: an engine 1; a torque converter 2; a forward-reverse switching mechanism 3; a variator 4 (continuously variable transmission); a final reduction mechanism 5; and drive wheels 6, 6.

With the engine 1, in addition to control of output torque by accelerator operation by a driver, control of output torque by an engine control signal from outside is possible. This engine 1 has an output torque control actuator 10 for performing output torque control using a throttle valve opening/closing operation, a fuel cutting operation, etc.

The torque converter 2 is a starting element having a torque increasing function, and when the torque increasing function is not needed, has a lock-up clutch 20 by which an engine output shaft 11 (=torque converter input shaft) and a torque converter output shaft 21 can be directly connected. This torque converter 2 has as constituent elements: a turbine runner 23 connected to the engine output shaft 11 via a converter housing 22; a pump impeller 24 connected to the torque converter output shaft 21; and a stator 26 provided in a case with a one-way clutch 25 interposed.

The forward-reverse switching mechanism 3 is a mechanism for switching the input rotation direction to the variator 4 between the positive rotation direction during forward travel and the reverse rotation direction during reverse travel. This forward-reverse switching mechanism 3 has: a double pinion planetary gear 30; a forward clutch 31 using a plurality of clutch plates; and a reverse brake 32 using a plurality of brake plates. The forward clutch 31 is hydraulically fastened by a forward clutch pressure Pfc during selection of a forward travel range of the D range, etc. The reverse brake 32 is hydraulically fastened by reverse brake pressure Prb during selection of a reverse travel range of the R range, etc. The forward clutch 31 and the reverse brake 32 are both released by draining of the forward clutch pressure Pfc and the reverse brake pressure Prb during selection of the N range (neutral range, non-travel range).

The variator 4 has a primary pulley 42, a secondary pulley 43, and a pulley belt 44, and is provided with a continuously variable transmission function that continuously changes the transmission ratio (ratio of the variator input rotation speed and the variator output rotation speed) by changing of the belt contact diameter. The primary pulley 42 is configured by a fixed pulley 42a and a sliding pulley 42b that are arranged on the same axis of the variator input shaft 40, and the sliding pulley 42b does the sliding operation by the primary pressure Ppri guided to a primary pressure chamber 45. The secondary pulley 43 is configured by a fixed pulley 43a and a sliding pulley 43b arranged on the same axis of the variator output shaft 41, and the sliding pulley 43b does the sliding operation by the secondary pressure Psec guided to a secondary pressure chamber 46. The pulley belt 44 is stretched across a sheave surface that forms a V shape of the primary pulley 42, and a sheave surface that forms a V shape of the secondary pulley 43. This pulley belt 44 is formed by two sets of laminated rings for which a large number of annular rings are overlapped from inside to outside, and a punched plate material, and is configured by a large number of elements laminated in ring form and attached by pinching along the two sets of laminated rings. As the pulley belt 44, it is also possible to be a chain type belt for which a large number of chain elements arrayed in the pulley advancing direction are joined by a pin that penetrates in the pulley axial direction.

The final reduction mechanism 5 is a mechanism that decelerates the variator output rotation speed from the variator output shaft 41 and also gives a differential function transmitted to the left and right drive wheels 6, 6. This final reduction mechanism 5 has as a reduction gear mechanism: a first gear 52 provided on the variator output shaft 41; a second gear 53 and a third gear 54 provided on an idler shaft 50; and a fourth gear 55 provided in the outer peripheral position of a differential case. Also, as a differential gear mechanism, there is a differential gear 56 interposed between the left and right drive shafts 51, 51.

As shown in FIG. 1, the control system of the engine vehicle is provided with: a hydraulic control unit 7 which is the hydraulic control system; and a CVT control unit 8 which is an electronic control system.

The hydraulic control unit 7 is a unit that does pressure regulation of: primary pressure Ppri guided to the primary pressure chamber 45; secondary pressure Psec guided to the secondary pressure chamber 46; forward clutch pressure Pfc to the forward clutch 31; and reverse brake pressure Prb to the reverse brake 32. This hydraulic control unit 7 is provided with: an oil pump 70 that is rotationally driven by the engine 1 which is a drive source for travel; and a hydraulic control circuit 71 for doing pressure regulation of various types of control pressure based on discharge pressure from the oil pump 70. The hydraulic control circuit 71 has: a line pressure solenoid valve 72; a primary pressure solenoid value 73; a secondary pressure solenoid valve 74; a forward clutch pressure solenoid valve 75; and a reverse brake pressure solenoid valve 76. Each solenoid valve 72, 73, 74, 75, 76 does pressure regulation of each command pressure by differentiating the On/Off ratio (duty ratio) according to the duty command value output from the CVT control unit 8.

The line pressure solenoid valve 72 does pressure regulation of the discharge pressure from the oil pump 70 to the commanded line pressure PL, according to the line pressure command value output from the CVT control unit 8. This line pressure PL is the source pressure when doing pressure regulation of various types of control pressure, and is used as hydraulic pressure for suppressing belt slip and clutch slip with respect to torque for transmission of the drive system.

The primary pressure solenoid valve 73 does pressure reducing regulation to a commanded primary pressure Ppri with the line pressure PL as the source pressure according to a primary pressure command value output from the CVT control unit 8. The secondary pressure solenoid valve 74 does pressure reducing regulation to a commanded secondary pressure Psec with the line pressure PL as the source pressure according to a secondary pressure command value output from the CVT control unit 8.

The forward clutch pressure solenoid valve 75 does pressure reducing regulation to a commanded forward clutch pressure Pfc with the line pressure PL as the source pressure according to a forward clutch pressure command value output from the CVT control unit 8. The reverse brake pressure solenoid valve 76 does pressure reducing regulation to a commanded reverse brake pressure Prb with the line pressure PL as the source pressure according to the reverse brake pressure command value output from the CVT control unit 8.

The CVT control unit 8 performs line pressure control, transmission hydraulic control, forward-reverse switching control, etc. With the line pressure control, a command value for obtaining a target line pressure according to the throttle opening degree, etc., is output to the line pressure solenoid valve 72. With the transmission control, when a target transmission ratio (target primary rotation speed Npri *) is determined, a hydraulic pressure command value for obtaining the determined target transmission ratio (target primary rotation speed Npri *) is output to the primary pressure solenoid valve 73 and the secondary pressure solenoid valve 74. With the forward-reverse switching control, a command value for controlling the engagement/release of the forward clutch 31 and the reverse brake 32 according to the selected range position is output to the forward clutch pressure solenoid valve 75 and the reverse brake pressure solenoid valve 76.

Sensor information and switch information such as from a turbine rotation speed sensor 80, a vehicle speed sensor 81, a secondary pressure sensor 82, an oil temperature sensor 83, an inhibitor switch 84, a brake switch 85, an accelerator opening sensor 86, a primary pressure sensor 87, a forward-reverse G sensor 89, etc., are input to the CVT control unit 8. Also, from the engine control unit 88 for which sensor information from the engine rotation speed sensor 12 is input, engine torque information is input, and an engine torque request is output to the engine control unit 88. The inhibitor switch 84 detects the selected range position (D range, N range, R range, etc.), and outputs the range position signal according to the range position.

### Transmission Control Configuration

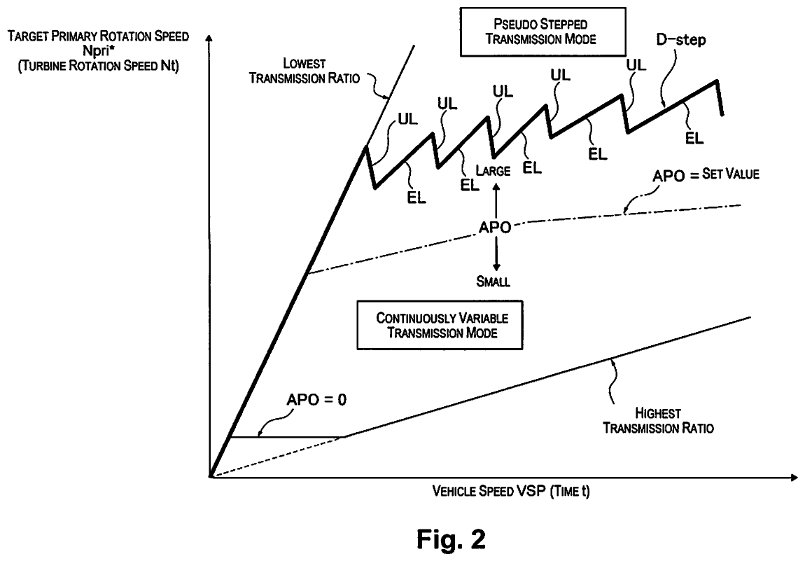

FIG. 2 shows a summary of the transmission schedule used when executing transmission control of the variator 4. Hereafter, the transmission control configuration is explained based on FIG. 2.

As transmission control modes of the variator 4 executed by the CVT control unit 8, there are a continuously variable transmission mode when pseudo stepped transmission start conditions are not established, and pseudo stepped transmission mode when pseudo stepped transmission start conditions are established.

The continuously variable transmission mode is a transmission mode that, for example, is selected when there is no acceleration intent with the accelerator opening APO less than the set opening degree, and the pseudo stepped transmission start conditions are not established, and executes continuously variable transmission for changing the transmission ratio of the variator 4 to continuously variable. This continuously variable transmission mode uses a transmission schedule shown in FIG. 2 set so as to change the transmission ratio to continuously variable in a range of the transmission ratio width using the lowest transmission ratio and the highest transmission ratio according to operating points (VSP, APO). In other words, when the pseudo stepped transmission start conditions are not established, continuously variable transmission is done by determining the target primary rotation speed Npri * using the operating points (VSP, APO) on the transmission schedule of FIG. 2. For example, when the vehicle speed VSP is constant, when the accelerator depression operation is performed, the target primary rotation speed Npri * rises, continuously variable transmission is done in the downshift direction, and when the accelerator depression return operation is performed, the target primary rotation speed Npri * decreases, and continuously variable transmission is done in the upshift direction. When the accelerator opening APO is constant, when the vehicle speed VSP rises, there is continuously variable transmission in the upshift direction, and when the vehicle speed VSP decreases, there is continuously variable transmission in the downshift direction.

The pseudo stepped transmission mode is a transmission mode for which, for example, when there is acceleration intent with the accelerator opening APO at the set opening degree or greater, and the pseudo stepped transmission start conditions are established, pseudo stepped upshift that changes the transmission ratio of the variator 4 in stepped form is executed, simulating stepped transmission. The pseudo stepped upshift sets the pseudo stepped upshift characteristic line D-step by repetition of a transmission ratio suppression phase line EL and a upshift phase line UL according to the size of the vehicle speed VSP, the accelerator opening APO, and the transmission ratio i, to a two dimensional coordinate surface using a time axis and a turbine rotation speed axis. Also, when the pseudo stepped upshift characteristic line D-step is set, this is performed by a transmission ratio suppression phase in which as the time elapses, the turbine rotation speed Nt rises, and an upshift phase in which the turbine rotation speed Nt decreases being repeated in sawtooth form. Here, with the transmission ratio suppression phase, for example, by having the transmission ratio suppression phase line EL be an equal transmission ratio line, or a line near the inclination of an equal transmission ratio line, change in the transmission ratio of the variator 4 is suppressed. However, with the upshift phase, for example, the upshift phase line UL, by becoming a line for which the upshift phase line UL is a line for which the turbine rotation speed Nt decreases in a shorter time than the transmission ratio suppression phase, the transmission ratio of the variator 4 is upshifted.

The pseudo stepped upshift characteristic line D-step according to the horizontal axis shown by example in FIG. 2 being time t and the vertical axis being turbine rotation speed Nt, when pseudo stepped upshift is executed, shows the characteristic line when the vehicle speed VSP rises at a constant vehicle acceleration.

### Transmission Control Processing Configuration

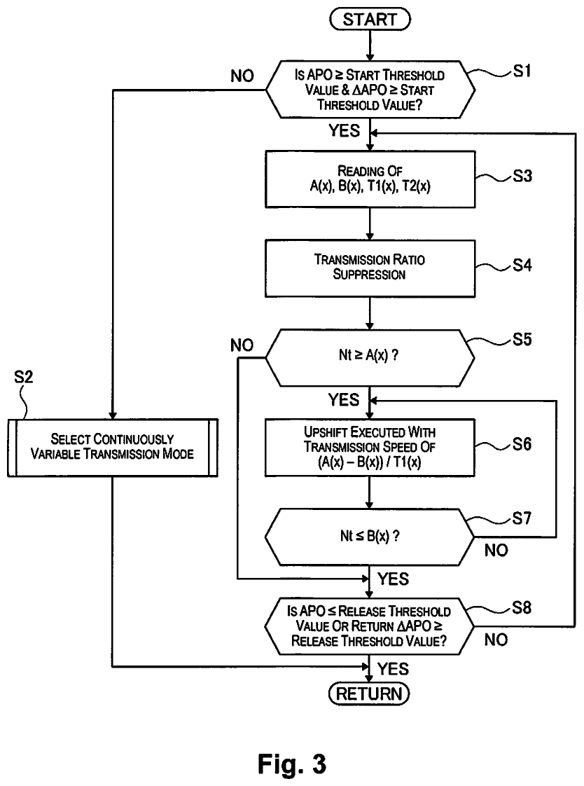

FIG. 3 shows the flow of the transmission control process executed by the CVT control unit 8 of embodiment 1. Following, each step of FIG. 3 representing the transmission control process configuration is explained.

At step S1, a judgment is made of whether the accelerator opening APO which is the pseudo stepped transmission start condition is a start threshold value or higher, and of whether the accelerator opening speed ΔAPO is the start threshold value or greater. When YES (APO≥start threshold value, and ΔAPO≥start threshold value), the process advances to step S3, and when NO (APO<start threshold value, or ΔAPO<start threshold value), the process advances to step S2.

Here, the accelerator opening APO is acquired from the accelerator opening sensor 86, and the accelerator opening speed ΔAPO is acquired by doing time differential processing of the sensor value from the accelerator opening sensor 86. The start threshold value of the accelerator opening APO is set to a value corresponding to the accelerator depression amount representing the acceleration intention of the driver. The start threshold value of the accelerator opening speed ΔAPO is set to a value corresponding to the accelerator depression speed representing the acceleration intention of the driver.

At step S2, following a judgment at step S1 that APO<start threshold value, or that ΔAPO<start threshold value, in other words, a judgment that the pseudo stepped transmission start conditions are not established, the continuously variable transmission mode is selected, continuously variable transmission control of the variator 4 is executed, and the process proceeds to Return.

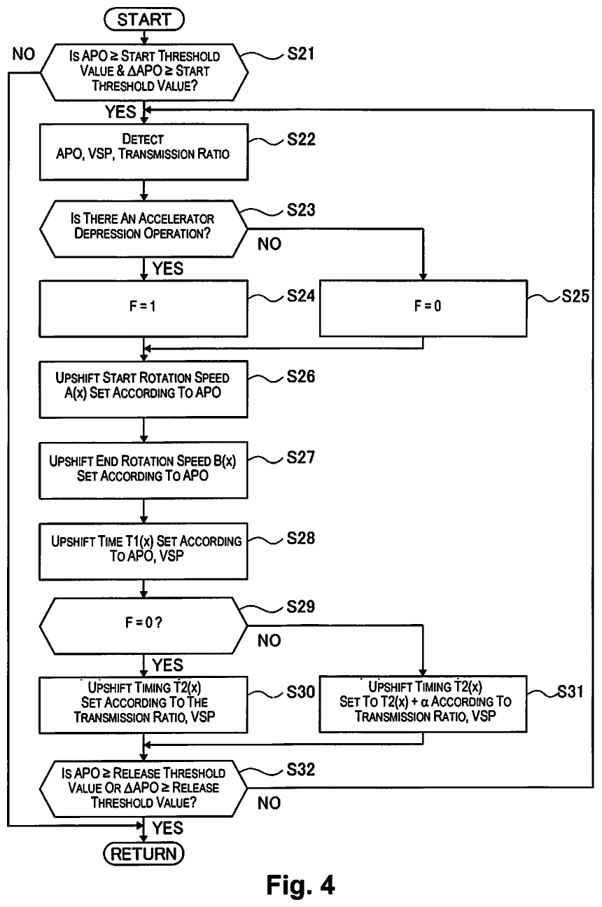

At step S3, following a judgment at step S1 that APO≥start threshold value, and ΔAPO≥start threshold value, A(x), B(x), T1(x), and T2(x) acquired using arithmetic processing using the flow chart shown in FIG. 4 are read, and the process advances to step S4.

Here, for (x), the initial value is (1), and when one set of the transmission ratio suppression phase and the upshift phase end, this is rewritten as shown by (x=1, 2, 3, 4 . . . n).

A(x) is the upshift start rotation speed, and is the turbine rotation speed Nt that starts the upshift phase.

B(x) is the upshift end rotation speed, and is the turbine rotation speed Nt that ends the upshift phase.

T1(x) is the upshift time, and is the required time from the upshift phase start time to the upshift phase end time.

T2(x) is the upshift timing, and is the required time from the current upshift phase start time until the next upshift phase start time, in other words, is the time needed to perform one set of the transmission ratio suppression phase and the upshift phase.

At step S4, following the reading of A(x), B(x), T1(x), and T2(x) at step S3, transmission control is executed by transmission ratio suppression for which the pseudo stepped upshift becomes the transmission ratio suppression phase, and the process advances to step S5.

Here, “transmission control by transmission ratio suppression” means

Executing transmission at the transmission speed Ve found using the formula:

Ve={A(x)−B(x−1)}/{T2(x)−T1(x)} (1)

B(x−1) is the previously read upshift end rotation speed, and the B(x−1) with the initial transmission ratio suppression control is the turbine rotation speed Nt at the point when the pseudo stepped transmission start conditions are established.

At step S5, following transmission control by transmission ratio suppression at step S4, a judgment is made of whether the turbine rotation speed Nt has become the current upshift start rotation speed A(x) or greater. If YES (Nt≥A(x)), the process advances to step S6, and if NO (Nt<A(x)), the process advances to step S8. The information of the turbine rotation speed Nt is acquired from the turbine rotation speed sensor 80.

At step S6, following a judgment at step S5 that Nt≥A(x), or a judgment at step S7 that Nt>B(x), upshift for which the pseudo stepped upshift becomes the upshift phase is executed, and the process advances to step S7.

Here, “upshift” means:

Execution of upshifting at transmission speed Vu found with the formula:

Vu={A(x)−B(x)}/T1(x) (2)

At step S7, following execution of the upshift at step S6, a judgment is made of whether the turbine rotation speed Nt is the current upshift end rotation speed B(x) or lower. If YES (Nt≤B(x)), the process advances to step S8, and if NO (NT>B(x)), the process returns to step S6. The information of the turbine rotation speed Nt is acquired from the turbine rotation speed sensor 80.

At step S8, following a judgment at step S5 that Nt<A(x), or a judgment at step S7 that Nt≤B(x), a judgment is made of whether the accelerator opening APO is the release threshold value or less, or whether the accelerator return speed ΔAPO is the release threshold value or greater, which are the pseudo stepped transmission release conditions. If YES (APO≤release threshold value, or ΔAPO≥release threshold value), the process proceeds to Return, and if NO (APO>release threshold value, and ΔAPO<release threshold value), the process returns to step S3.

Here, the release threshold value of the accelerator opening APO is set to a value corresponding to an accelerator return amount representing a deceleration intention of the driver (value smaller than the start threshold value). The release threshold value of the accelerator return speed ΔAPO is set to a value corresponding to an accelerator return speed representing a deceleration intention of the driver.

### Required Information Acquisition Process Configuration With Pseudo Stepped Upshift

FIG. 4 shows the flow of the required information acquisition process for determining the pseudo stepped upshift characteristic line D-step by repetition of the transmission ratio suppression phase line EL and the upshift phase line UL when the pseudo stepped upshift mode is selected. Following, each step of FIG. 4 representing the required information acquisition processing configuration with pseudo stepped upshift is explained.

At step S21, the same as with step S1 in FIG. 3, a judgment is made of whether the accelerator opening APO is the start threshold value or greater, and whether the accelerator opening speed ΔAPO is the start threshold value or greater, which are the pseudo stepped transmission start conditions. If YES (APO≥start threshold value, and ΔAPO≥start threshold value), the process advances to step S22, and if NO (APO<start threshold value, or ΔAPO<start threshold value), the process proceeds to Return.

At step S22, following a judgment at step S21 that APO≥start threshold value, and ΔAPO≥start threshold value, or at step S32 that APO≤release threshold value, or ΔAPO≥release threshold value, the accelerator opening APO, the vehicle speed VSP, and the transmission ratio i are detected, and the process advances to step S23.

Here, the accelerator opening APO is acquired from the accelerator opening sensor 86, and the vehicle speed VSP is acquired from the vehicle speed sensor 81. The transmission ratio i is acquired by a rotation speed ratio calculation using the transmission input rotation speed based on the sensor value from the turbine rotation speed sensor 80, and the transmission output rotation speed based on the sensor value from the vehicle speed sensor 81.

At step S23, following detection of the APO, VSP, and transmission ratio at step S22, a judgment is made of whether there was an accelerator depression operation. If YES (there is an accelerator depression operation), the process advances to step S24, and if NO (there is no accelerator depression operation), the process advances to S25.

Here, with the accelerator depression operation, if the difference (APO(n)-APO(n-1)) between the previously detected accelerator opening APO(n-1) and the currently detected accelerator opening APO(n) is a depression judgment threshold value or greater, it is judged that there is an accelerator depression operation.

At step S24, following the judgment at step S23 that there is an accelerator depression operation, the accelerator depression flag F is switched from F=0 to F=1, and the process advances to step S26.

At step S25, following the judgment at step S23 that there is no accelerator depression operation, the accelerator depression flag F is left as F=0, or is switched from F=1 to F=0, and the process advances to step S26.

At step S26, following the setting of the accelerator depression flag F of step S24 or step S25, the upshift start rotation speed A(x) is set according to the accelerator opening APO, and the process advances to step S27.

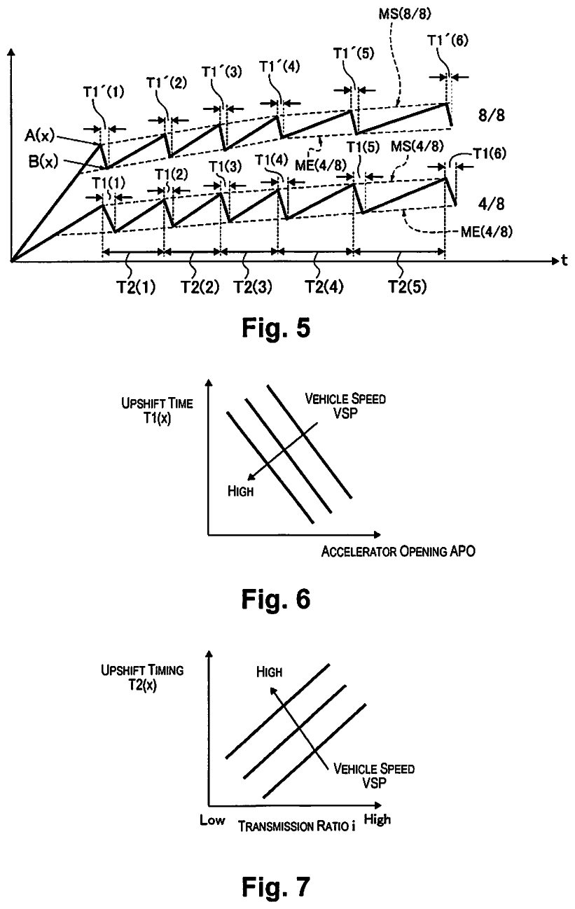

Here, as shown in FIG. 5, setting of the upshift start rotation speed A(x) is determined using a 4/8 upshift judgment map MS(4/8) when the accelerator opening APO is opening degree 4/8, and using an 8/8 upshift judgment map MS(8/8) when the accelerator opening APO is opening degree 8/8. In other words, the higher the degree of the accelerator opening APO, the higher the value that the upshift start rotation speed A(x) by the turbine rotation speed Nt is set to.

At step S27, following setting of the upshift start rotation speed A(x) at step S26, the upshift end rotation speed B(x) according to the accelerator opening APO is set, and the process advances to step S28.

Here, as shown in FIG. 5, setting of the upshift end rotation speed B(x) is determined using a 4/8 upshift judgment map ME(4/8) when the accelerator opening APO is opening degree 4/8, and using an 8/8 upshift judgment map ME(8/8) when the accelerator opening APO is opening degree 8/8. In other words, the higher the degree of the accelerator opening APO, the higher the value that the upshift end rotation speed B(x) by the turbine rotation speed Nt is set to. The turbine rotation speed difference between the upshift start rotation speed A(x) and the upshift end rotation speed B(x) is the setting of an almost constant rotation speed difference regardless of the height of the vehicle speed VSP, but the higher the degree of the accelerator opening APO, the smaller the rotation speed difference.

At step S28, following the setting of the upshift end rotation speed B(x) at step S27, the upshift time T1(x) is set according to the accelerator opening APO and the vehicle speed VSP, and the process advances to step S29.

Here, for the setting of the upshift time T1(x), using the upshift time setting map shown in FIG. 6, the bigger the degree of the accelerator opening APO, the shorter a time the upshift time T1(x) is set to. Also, when the accelerator opening APO is the same opening degree, the higher the vehicle speed VSP, the shorter a time the upshift time T1(x) is set to. FIG. 5 shows the upshift times T1(1), T1(2), T1(3), T1(4), T1(5), T1(6) when the accelerator opening APO is an opening degree of 4/8, and the upshift times T1′(1), T1′(2), T1′(3), T1′(4), T1′(5), T1′(6) when the accelerator opening APO is an opening degree of 8/8.

At step S29, following setting of the upshift time T1(x) at step S28, a judgment is made of whether the accelerator depression flag F is F=0. If YES (F=0), the process advances to step S30, and if NO (F=1), the process advances to step S31.

At step S30, following the judgment at step S29 that F=0, the upshift timing T2(x) when F=0 according to the transmission ratio i and the vehicle speed VSP is set, and the process advances to step S32.

Here, for the setting of the upshift timing T2(x) when F=0, using the upshift timing setting map shown in FIG. 7, the more the transmission ratio i is to the high transmission ratio side, the longer a time the upshift timing T2(x) is set to. Also, when the transmission ratio i is the same, the higher that the vehicle speed VSP, the longer a time the upshift timing T2(x) is set to. FIG. 5 shows the upshift timings T2(1), T2(2), T2(3), T2(4), T2(5) when the accelerator opening APO is an opening degree of 4/8.

At step S31, following the judgment that F=1 at step S29, the upshift timing T2(x) when F=1 according to the transmission ratio i and the vehicle speed VSP is set, and the process advances to step S32.

Here, for the setting of the upshift timing T2(x) when F=1, this is set using (T2(x)+α) for which an extension time α is added to the upshift timing T2(x) set using the upshift timing setting map shown in FIG. 7. In other words, when the accelerator depression operation is done by the driver, the upshift timing is extended by one time thereafter.

At step S32, following the setting of the upshift timing T2(x) at step S30 or step S31, the same as with step S8 in FIG. 3, a judgment is made of whether the accelerator opening APO is the release threshold value or less, or the accelerator return speed ΔAPO is the release threshold value or greater, which are the pseudo stepped transmission release conditions. If YES (APO≤release threshold value, or ΔAPO≥release threshold value), the process proceeds to Return, and if NO (APO>release threshold value, and ΔAPO<release threshold value), the process returns to step S22.

Next, the operation is explained.

The operation of embodiment 1 is explained divided into the “Transmission Control Process Operation,” “Required Information Acquisition Process Operation with Pseudo Stepped Upshift,” “Transmission Control Operation by Changing the Upshift Time,” “Transmission Control Operation by Changing the Upshift Timing,” and “Transmission Control Operation by Interposition of the Accelerator Depression Operation.”

### Transmission Control Process Operation

First, the transmission control process operation is explained based on the flow chart shown in FIG. 3.

In a travel scene in which the accelerator depression operation amount is suppressed, etc., APO<start threshold value, or ΔAPO<start threshold value, and when the pseudo stepped transmission start conditions are not established, in the flow chart in FIG. 3, the flow that advances from step S1→step S2→Return is repeated. At step S2, the continuously variable transmission mode is selected, and continuously variable transmission control that changes the transmission ratio of the variator 4 continuously is executed.

Meanwhile, during start or intermediate acceleration by the accelerator depression operation, when APO≥start threshold value, and ΔAPO≥start threshold value, and the pseudo stepped transmission start conditions are established, in the flow chart of FIG. 3, the process advances from step S1→step S3→step S4→step S5. At step S3, the upshift start rotation speed A(x), the upshift end rotation speed B(x), the upshift time T1(x), and the upshift timing T2(x) acquired by the arithmetic processing using the flow chart shown in FIG. 4 are read. At step S4, the transmission control using the transmission ratio suppression with which the pseudo stepped upshift is in the transmission ratio suppression phase is executed. At step S5, a judgment is made of whether the turbine rotation speed Nt has reached the current upshift start rotation speed A(x) or greater. While judged to be Nt<A(x) at step S5, the flow advancing from step S3→step S4→step S5→step S8 is repeated.

When it is judged that Nt≥A(x) at step S5, the process advances from step S5 to step S6→step S7, and while it is judged that Nt>B(x) at step S7, the flow advancing from step S6→step S7 is repeated. At step S6, the upshift for which the pseudo stepped upshift is the upshift phase is executed.

When it is judged that Nt≤B(x) at step S7, the process advances from step S7 to step S8→step S3→step S4→step S5. Also, the flow of the process from step S3=step S4→step S5→step S8 is repeated, and the transmission control by transmission ratio suppression is executed again. During transmission control by transmission ratio suppression, when it is judged that Nt≥A(x) at step S5, the process advances from step S5 to step S6→step S7, and the upshift is executed again.

In this way, when the pseudo stepped transmission start conditions are established, the selection is switched from the continuously variable transmission mode to the pseudo stepped transmission mode. Also, when the pseudo stepped transmission mode is selected, while the pseudo stepped transmission release conditions are judged to be not established at step S8, execution of the pseudo stepped upshift that repeats the transmission ratio suppression phase and the upshift phase is maintained. Also, when the pseudo stepped transmission release conditions are established at step S8, the flow that advances from step S8 to step S1→step S2→Return is repeated, and the selection is switched from the pseudo stepped transmission mode to the continuously variable transmission mode.

### Required Information Acquisition Process Operation With Pseudo Stepped Upshift

Next, the required information acquisition process operation for determining the pseudo stepped upshift characteristic line D-step is explained based on the flow chart shown in FIG. 4.

In a travel scene in which the accelerator depression operation amount is suppressed, etc., when APO<start threshold value, or ΔAPO<start threshold value, and the pseudo stepped transmission start conditions are not established, in the flow chart of FIG. 4, the flow advancing from step S21→Return is repeated. In other words, while the pseudo stepped transmission start conditions are not established, the process for acquiring the required information for determining the pseudo stepped upshift characteristic line D-step is not performed.

Meanwhile, when in a starting scene or intermediate acceleration scene by an accelerator depression operation, etc., when APO≥start threshold value, and ΔAPO≥start threshold value, and the pseudo stepped transformation start conditions are established, in the flow chart of FIG. 4, the process advances from step S21→step S22→step S23. At step S22, the accelerator opening APO, the vehicle speed VSP, and the transmission ratio i are detected. Next, at step S23, a judgment is made of whether there was an accelerator depression operation. When it is judged that there is an accelerator depression operation, the process advances to step S24, and at step S24, the accelerator depression flag F is switched from F=0 to F=1. When it is judged that there is no accelerator depression operation, the process advances to step S25, and at step S25, the accelerator depression flag F is left as F=0, or is switched from F=1 to F=0.

When the accelerator depression flag F is set at step S24 or step S25, the process advances from step S26→step S27→step S28→step S29. At step S26, the upshift start rotation speed A(x) is set according to the accelerator opening APO. At step S27, the upshift end rotation speed B(x) is set according to the accelerator opening APO. At step S28, the upshift time T1(x) is set according to the accelerator opening APO and the vehicle speed VSP. At step S29, a judgment is made of whether the accelerator depression flag F is F=0 or not. When the accelerator depression flag F=0, the process advances to step S30, and at step S30, the upshift timing T2(x) when F=0 according to the transmission ratio i and the vehicle speed VSP is set. Meanwhile, when the accelerator depression flag F=1, the process advances to step S31, and at step S31, the upshift timing (T2(x)+α) when F=1 according to the transmission ratio i and the vehicle speed VSP is set. The upshift timing (T2(x)+α) when F=1 is the time set by adding an extension time α to the upshift timing T2(x) set using the upshift timing setting map shown in FIG. 7.

At step S32, a judgment is made of whether the accelerator opening APO is the release threshold value or less, or the accelerator return speed ΔAPO is the release threshold value or greater, which are the pseudo stepped transmission release conditions. While the pseudo stepped transmission release conditions are not established, the process returns from step S32 to step S22, and the process of acquiring the upshift start rotation speed A(x), the upshift end rotation speed B(x), the upshift time T1(x), and the upshift timing T2(x) is repeated. Also, when the pseudo stepped transmission release conditions are established, the process proceeds from step S32 to Return, and until the pseudo stepped transmission start conditions are established next, the flow of advancing from step S21→Return is repeated.

In this way, the process of acquiring the required information for determining the pseudo stepped upshift characteristic line D-step is performed repeatedly during execution of pseudo stepped upshift from the pseudo stepped transmission start conditions establishment timing until the pseudo stepped transmission release conditions establishment timing. By this repetition process, the required information is acquired for following at any time changes in the accelerator opening APO, changes in the vehicle speed VSP, or changes in the transmission ratio i. In particular, even if the accelerator depression operation is interposed during execution of the pseudo stepped upshift, the required information corresponding to the interposed operation is acquired.

### Transmission Control Operation by Changing the Upshift Time

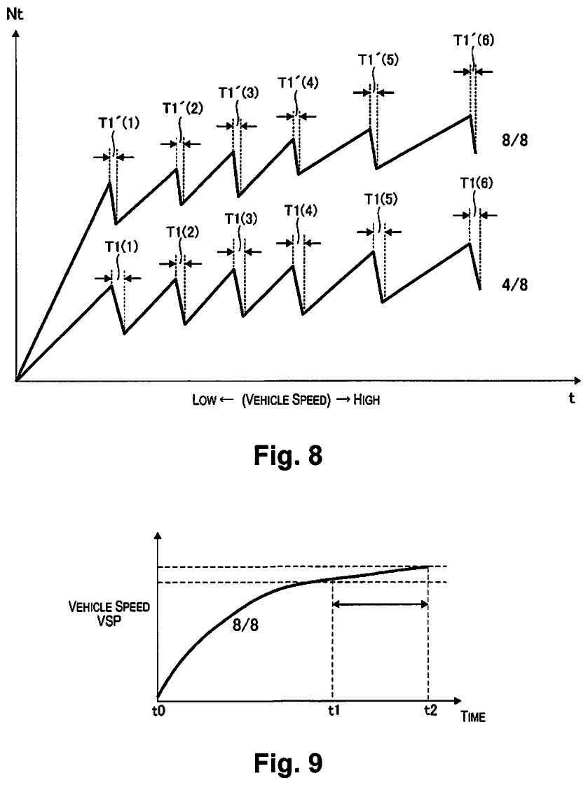

Following, the transmission control operation when the upshift time T1(x) is changed in the pseudo stepped upshift is explained based on the time chart shown in FIG. 8.

With embodiment 1, when performing the pseudo stepped upshift, as shown in FIG. 8, the higher the accelerator opening APO and the larger the acceleration intent, the shorter the upshift time T1(x) required for passing through the upshift phase is set to be.

For example, as shown in FIG. 8, the upshift time T1′(x) (=T1′(1) to T1′(6)) when the accelerator opening APO is an opening degree of 8/8 is set to a shorter time than the upshift time T1(x) (T1(1) to T1(6)) when the accelerator opening APO is an opening degree of 4/8. In this way, the greater the acceleration intention of the driver represented by the size of the accelerator opening APO, the shorter the upshift time T1(x) which is the time of the upshift phase between a transmission ratio suppression phase and the next transmission ratio suppression phase.

Specifically, the transmission ratio suppression phase of the pseudo stepped upshift is a phase in which the transmission input rotation speed (engine rotation speed Ne) rises according to a rise in the transmission output rotation speed (vehicle speed VSP), and the function of ensuring the drive force is shared. Meanwhile, the upshift phase of the pseudo stepped upshift is a phase in which the transmission input rotation speed (engine rotation speed Ne) decreases with respect to a rise in the transmission output rotation speed (vehicle speed VSP), and the function of removing the drive force is shared.

Focusing on this point, when performing pseudo stepped upshift, by setting the upshift time T1(x) required to pass through the upshift phase to be shorter the greater the acceleration intention of the driver, the removal time of the drive force is according to the size of the acceleration intention. In other words, when the acceleration intention is great, by setting the upshift time T1(x) to be short, there is reduced interruption of the drive force, and it is possible to obtain an acceleration sense according to the accelerator depression operation amount of the driver. Also, when the acceleration intention is small, by setting the upshift time T1(x) to be longer than when the acceleration intention is great, the time between the transmission ratio suppression phases is longer. By doing this, regardless of the acceleration intention being small, the drive force removal time being unnecessarily short, and obtaining a drive force that is larger than the drive force intended by the driver are prevented.

In this way, by setting the upshift time T1(x) which is the removal time of the drive force according to the size of the accelerator opening APO, when performing pseudo stepped upshift, an acceleration sense that matches the acceleration intention of the driver is obtained.

With embodiment 1, when performing pseudo stepped upshift, as shown in FIG. 8, the higher the vehicle speed VSP, the shorter the upshift time T1(x) required to pass through the upshift phase is set to.

For example, as shown in FIG. 8, when the accelerator opening APO is of opening degree 4/8, as shown with T1(1)≥T1(2)≥T1(3)≥T1(4)≥T1(5)≥T1(6), the higher the vehicle speed VSP, the shorter the upshift time T1(x). Similarly also when the accelerator opening APO is of opening degree 8/8, as shown with T1′(1)≥T1′(2)≥T1′(3)≥T1′(4)≥T1′(5)≥T1′(6), the higher the vehicle speed VSP, the shorter the upshift time T1′(x). In this way, the higher the vehicle speed VSP, the shorter the upshift time T1(x) which is the time of the upshift phase between a transmission ratio suppression phase and the next transmission ratio suppression phase.

Specifically, the higher the vehicle speed VSP, the greater the increase in the travel resistance received by the vehicle due to air resistance, etc. For this reason, for example, when the output from the engine 1 is the same with accelerator opening APO of opening degree 8/8, as shown in FIG. 9, the vehicle speed change amount (acceleration) becomes greater in the low vehicle speed range (time t0 to t1), but the vehicle speed change amount (acceleration) becomes smaller in the high vehicle speed range (time t1 to t2).

Therefore, the higher the vehicle speed VSP, the shorter time the upshift time T1(x) is set to, and by making the interruption of the drive force (time of removal of the drive force) short, the actual power performance is drawn out effectively, and the vehicle speed change amount is ensured even in the high vehicle speed range. As a result, when the vehicle speed VSP rises while executing the pseudo stepped upshift, it is possible to give the driver a good acceleration sense.

### Transmission Control Operation by Changing the Upshift Timing

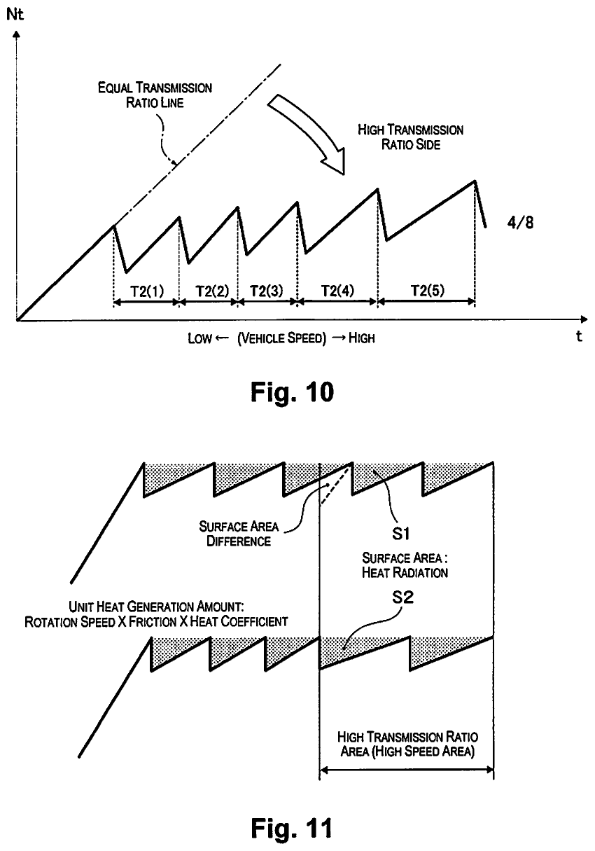

Following, the transmission control operation when the upshift timing T2(x) is changed in the pseudo stepped upshift is explained based on the time chart shown in FIG. 10.

With embodiment 1, when performing the pseudo stepped upshift, the higher side transmission ratio that the transmission ratio of the variator 4 is, the longer the upshift timing T2(x) is set.

For example, as shown in FIG. 10, when the accelerator opening APO is kept at a constant opening degree of opening degree 4/8, as shown with T2(1)≤T2(2)≤(T2(3)≤T2(4)≤T2(5), the higher side transmission ratio that the transmission ratio of the variator 4 is, the longer the upshift timing T2(x).

Specifically, in a state when the accelerator pedal depression amount is shallow, the transmission ratio of the variator 4 is a high transmission ratio. In such a case, the acceleration intention of the driver can be said to be low. For this reason, in the high transmission ratio area for which the acceleration intention is low, the upshift timing T2(x) that is the time interval after the current upshift until the next upshift is made longer.

Therefore, when performing the pseudo stepped upshift, there is a reduction in giving an acceleration sense unnecessarily in a high transmission ratio area of the variator 4, and also a reduction in the unit heat generation amount of the continuously variable transmission unit with the variator 4 built in.

Here, the unit heat generation amount is explained based on FIG. 11. The pseudo stepped upshift characteristic line noted in the upper part of FIG. 11 shows the characteristic line of a comparison example for which the upshift timing is set to a constant time regardless of the transmission ratio. The pseudo stepped upshift characteristic line noted in the lower part of FIG. 11 shows the characteristic line of embodiment 1 for which the upshift timing T2(x) becomes longer the more that the transmission ratio of the variator 4 is at the higher side transmission ratio.

The unit heat generation amount is expressed by the formula:

Unit heat generation amount=Rotation speed×Friction×Heat coefficient

Thus, in the high transmission ratio area (high speed area) for which the engine rotation speed Ne is high, the upshift phase frequency is low, and the unit heat generation amount is suppressed to be lower the greater that the heat radiating surface area is.

In contrast to this, when the upshift phase is compared in the high transmission ratio area (high speed area), in the case of the comparison example, the upshift phase frequency in the high transmission ratio area (high speed area) is twice, whereas with embodiment 1, the upshift phase frequency in the high transmission ratio area (high speed area) is once. Also, when comparing the surface area sandwiched by the upshift judgment map in the high transmission ratio area (high speed area) and the pseudo stepped upshift characteristic line (=heat radiation surface area), the heat radiation surface area S2 of embodiment 1 is broader than heat radiation surface area S1 of the comparison example (surface area difference).

Therefore, in the case of embodiment 1 for which the upshift timing T2(x) is made longer the more to the higher side transmission ratio that the transmission ratio of the variator 4 is, compared to the comparison example, the unit heat generation amount of the continuously variable transmission unit that has the variator 4 built in is decreased.

With embodiment 1, when performing the pseudo stepped upshift, the higher that the vehicle speed VSP is, the longer that the upshift timing T2(x) is set.

For example, as shown in FIG. 10, when the accelerator opening APO is kept at a constant opening degree of opening degree 4/8, as with T2(1)≤T2(2)≤T2(3)≤T2(4)≤T2(5), the higher the vehicle speed VSP, the longer the upshift timing T2(x) is made to be.

Specifically, the demand for high responsiveness with respect to the drive force request of the driver is in the area where the vehicle VSP is low. In other words, the current vehicle speed VSP is low, and there is a desire to accelerate and increase the vehicle speed VSP, so acceleration is requested. For this reason, in the high speed area in which the vehicle speed VSP is high, the upshift timing T2(x) which is the time interval after the current upshift until the next upshift is made longer.

Therefore, when performing pseudo stepped upshift, the giving of an acceleration sense unnecessarily in the high speed area is decreased, and also, the unit heat generation amount of the continuously variable transmission unit having the variator 4 built in is decreased.

The reason for the unit heat generation amount decreasing is as explained above using FIG. 11. Thus, in the case of embodiment 1 with which the upshift timing T2(x) is made longer the higher the vehicle speed VSP is, compared to the comparison example, the unit heat generation amount of the continuously variable transmission unit having the variator 4 built in is decreased.

### Transmission Control Operation by Interposition of the Accelerator Depression Operation

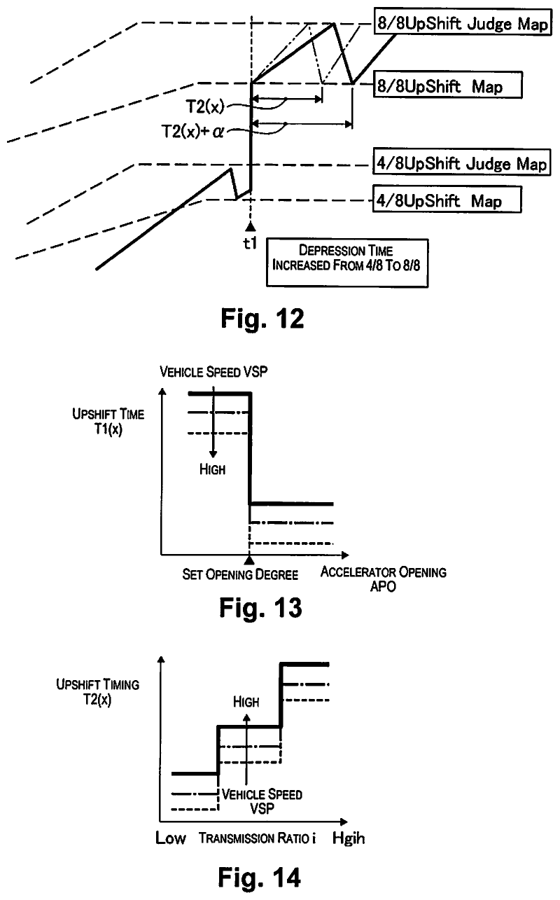

Following, the transmission control operation when the accelerator depression operation is interposed midway during pseudo stepped upshift is explained based on the time chart shown in FIG. 12.

With embodiment 1, when the accelerator opening APO became high midway during the pseudo stepped upshift, the upshift timing (T2(x)+α) set initially after the accelerator opening APO became high is made longer than the upshift timing T2(x) set based on the accelerator opening APO that became high.

For example, as shown in FIG. 12, when the accelerator opening APO is depressed from opening degree 4/8 to opening degree 8/8 at time t1, the upshift timing is given with an extension time α added to the upshift timing T2(x) found using the map with opening degree APO=8/8.

Specifically, when the accelerator depression operation is performed by the driver in a hill climbing scene or a passing scene, the state is such that the driver has an intention for a further drive force increase or acceleration. In such a case, by making the upshift timing, which is the upshift phase interval, longer only one time directly after the acceleration intention became greater, the travel time by the transmission ratio suppression phase becomes longer. By doing this, a large drive force is obtained, and it is possible to generate sufficient drive force with respect to the increase in the acceleration intention represented by the accelerator depression operation. In other words, when the accelerator depression operation is performed midway in the pseudo stepped upshift, emphasis is placed on the drive performance more than the shift feeling.

Therefore, when the accelerator depression operation is performed midway in the pseudo stepped upshift, by making the upshift timing longer only once directly after the acceleration intention became greater, a sufficient drive force is obtained according to the increase in the acceleration intention. As a result, with the hill climbing scene, it is possible to run on an uphill road with drive force that overcomes the road surface gradient, and in the passing scene, it is possible to pass the preceding car smoothly while increasing the acceleration level of the host vehicle.

Next, the effects are explained.

The effects noted below can be obtained with the transmission control device and the transmission control method of the continuously variable transmission of embodiment 1.

(1) Provided are: a continuously variable transmission (variator 4) arranged between the drive source for traveling (engine 1) and the drive wheels 6, 6; and the transmission control means (CVT control unit 8).

When the pseudo stepped transmission start conditions are not established, the transmission control means (CVT control unit 8) selects the continuously variable transmission mode that changes the transmission ratio of the continuously variable transmission (variator 4) to continuously variable, and when the pseudo stepped transmission start conditions are established, selects the pseudo stepped transmission mode that changes the transmission ratio of the continuously variable transmission (variator 4) in stepped form, simulating stepped transmission.

In this vehicle, when the pseudo stepped transmission mode is selected, the transmission control means (CVT control unit 8) performs the pseudo stepped upshift that repeats the transmission ratio suppression phase in which changes in the transmission ratio of the continuously variable transmission (variator 4) are suppressed, and the upshift phase in which the transmission ratio of the continuously variable transmission (variator 4) is upshifted.

When performing the pseudo stepped upshift, the greater the acceleration intention, the shorter the upshift time T1(x) required to pass through the upshift phase is set.

For this reason, when performing the pseudo stepped upshift, it is possible to provide the transmission control device of the continuously variable transmission (variator 4) that obtains an acceleration sense matching the acceleration intention of the driver.

(2) When performing the pseudo stepped upshift, the transmission control means (CVT control unit 8) sets the upshift time T1(x) required to pass through the upshift phase to be shorter the higher that the vehicle speed VSP is.

For this reason, in addition to the effect of (1), it is possible to give the driver a good acceleration sense with the vehicle speed change amount ensured even in a high vehicle speed area, by setting the upshift time T1(x) to be a short time the higher that the vehicle speed VSP is.

(3) When the time required to pass through one shift unit of a total of the transmission ratio suppression phase and the upshift phase is called the upshift timing T2(x), the transmission control means (CVT control unit 8), when performing the pseudo stepped upshift, sets the upshift timing T2(x) to be longer the more to the high side transmission ratio that the transmission ratio of the continuously variable transmission (variator 4) is.

For this reason, in addition to the effect of (1) or (2), when performing the pseudo stepped upshift, it is possible to reduce the giving of the acceleration sense unnecessarily in the high transmission ratio area of the continuously variable transmission (variator 4), and to reduce the unit heat generation amount.

(4) When performing the pseudo stepped upshift, the transmission control means (CVT control unit 8) sets the upshift timing T2(x) to be longer the higher that the vehicle speed VSP is.

For this reason, in addition to the effect of (3), when performing the pseudo stepped upshift, it is possible to reduce the giving of an acceleration sense unnecessarily in the high speed area of the vehicle speed VSP, and to reduce the unit heat generation amount.

(5) When the acceleration intention becomes greater midway in the pseudo stepped upshift, the transmission control means (CVT control unit 8) makes the upshift timing (T2(x)+α) set initially after the acceleration intention became greater to be longer than the upshift timing T2(x) set based on the acceleration intention that became greater.

For this reason, in addition to the effect of (3) or (4), when the accelerator depression operation is performed midway in the pseudo stepped upshift, it is possible to obtain sufficient drive force according to the increase in the acceleration intention.

(6) Provided is the continuously variable transmission (variator 4) arranged between the travel drive source (engine 1) and the drive wheels 6, 6.

The continuously variable transmission (variator 4) has as transmission modes: the continuously variable transmission mode that changes the transmission ratio continuously, and the pseudo stepped transmission mode that changes the transmission ratio in stepped fashion, simulating stepped transmission.

When performing the pseudo stepped upshift, the greater the acceleration intention, the shorter that the upshift time T1(x) required to pass through the upshift phase is set.

For this reason, when performing the pseudo stepped upshift, it is possible to provide the transmission control method of the continuously variable transmission (variator 4) that obtains an acceleration sense matching the acceleration intention of the driver.

Above, the transmission control device and the transmission control method of the continuously variable transmission of the present invention were explained based on embodiment 1. However, the specific configuration is not limited to this embodiment 1, and changes and additions to the design, etc., are permitted as long as they do not stray from the gist of the invention of each claim within the scope of patent claims.

With embodiment 1, an example was shown of determining the upshift time T1(x) using the upshift time map shown in FIG. 6 that changes the upshift time T1(x) gradually according to the accelerator opening APO and the vehicle speed VSP size. However, as the upshift time map, as shown in FIG. 13, it is also possible to determine the upshift time T1(x) with the accelerator opening APO being divided into two categories: being the set opening degree or greater, or less than that. Furthermore, it is also possible to determine the upshift time T1(x) with the area of the accelerator opening APO divided into multiple levels of three or more.

With embodiment 1, shown was an example of determining the upshift timing T2(x) using the upshift timing map shown in FIG. 7 made to change the upshift timing T2(x) gradually according to the transmission ratio i and vehicle speed VSP size. However, as the upshift timing map, as shown in FIG. 14, it is also possible to determine the upshift timing T2(x) with the transmission ratio i divided into three from lowest to highest. Furthermore, it is also possible to determine the upshift timing T2(x) with the transmission ratio area divided into two, or divided into a plurality of stages of four or more.

With embodiment 1, shown is an example of, when performing the pseudo stepped upshift, judging that the greater the opening degree of the accelerator opening APO, the greater the acceleration intention, and setting the upshift time T1(x) required to pass through the upshift phase to be shorter. However, the judgment that the acceleration intention is large can also be performed using the accelerator opening speed, and can be performed jointly with the accelerator opening and the accelerator opening speed.

With embodiment 1, shown is an example of giving the pseudo stepped transmission start conditions using the accelerator opening conditions and the accelerator opening speed conditions. However, as the pseudo stepped transmission start conditions, aside from the accelerator opening conditions and the accelerator opening speed conditions, it is also possible to add the vehicle speed condition of the vehicle speed VSP being the start threshold value or greater.

With embodiment 1, shown is an example of giving the pseudo stepped transmission release conditions using the accelerator opening conditions and the accelerator opening speed conditions. However, as the pseudo stepped transmission release conditions, aside from the accelerator opening conditions and the accelerator return speed conditions, it is also possible to add the vehicle speed condition that the vehicle speed VSP be the release threshold value or less. At this time, the release threshold value of the vehicle speed VSP can be made to be a lower vehicle speed value than the start threshold value of the vehicle speed VSP.

With embodiment 1, shown is an example of setting the upshift time T1(x) required to pass through the upshift phase to be shorter the larger that the accelerator opening APO is, or the higher that the vehicle speed VSP is, and of executing the upshift using the transmission speed at which the upshift is completed within the time. However, the shorter that the upshift time is, the greater the upshift shock. Therefore, the upshift time is set to be the time for which the upshift shock is the minimum value within the allowed range in the high opening degree and the high vehicle speed for which the upshift time is set to its shortest.

With embodiment 1, shown is an example of applying the transmission control device and the transmission control method of the continuously variable transmission of the present invention to an engine vehicle in which is mounted a belt type continuously variable transmission using a variator. However, the transmission control method and the transmission control device of the present invention can also be applied to a vehicle in which is mounted a continuously variable transmission with a sub-transmission mechanism that combines a sub-transmission mechanism and a variator, or a vehicle in which is mounted a toroidal type continuously variable transmission. Also, as the vehicle to which this is applied, is possible to apply this not only to an engine vehicle, but also to a hybrid car, an electric car, etc.

1. A transmission control device of a continuously variable transmission provided in a vehicle, the transmission control device comprising:
a continuously variable transmission arranged between a travel drive source and drive wheels; and
a transmission controller configured to select a continuously variable transmission mode that continuously changes a transmission ratio of the continuously variable transmission when a pseudo stepped transmission start condition is not established, and to select a pseudo stepped transmission mode that changes the transmission ratio of the continuously variable transmission in steps, simulating stepped transmission, when the pseudo stepped transmission start condition is established, wherein
when the pseudo stepped transmission mode is selected, the transmission controller is configured to perform pseudo stepped upshift which repeats a transmission ratio suppression phase in which changes in the transmission ratio of the continuously variable transmission are suppressed, and an upshift phase in which the transmission ratio of the continuously variable transmission is upshifted,
when performing the pseudo stepped upshift, the transmission controller is configured to determine an acceleration intention based on an accelerator opening degree and a vehicle speed. and to set upshift time required to pass through the upshift phase so that the larger the acceleration intention, the shorter the upshift time, and so that, for the same accelerator opening degree, the higher the vehicle speed, the shorter the upshift time.

2. (canceled)

3. The transmission control device of the continuously variable transmission according to claim 1, wherein
when upshift timing is time required to pass through one shift unit of a total of the transmission ratio suppression phase and the upshift phase,
the transmission controller is configured to set the upshift timing so that the more to a high side transmission ratio that the transmission ratio of the continuously variable transmission is, the longer the upshift timing is.

4. The transmission control device of the continuously variable transmission according to claim 3, wherein
when performing the pseudo stepped upshift, the transmission controller is configured to set the upshift timing so that the higher the vehicle speed is, the longer the upshift timing is.

5. The transmission control device of the continuously variable transmission according to claim 3, wherein
when the acceleration intention becomes greater midway in the pseudo stepped upshift, the transmission controller is configured to make the upshift timing set initially after the acceleration intention became greater to be longer than the upshift timing set based on the acceleration intention that became greater.

6. A transmission control method of a continuously variable transmission arranged between a travel drive source and drive wheels, where the continuously variable transmission has as transmission modes: a continuously variable transmission mode that changes the transmission ratio continuously, and a pseudo stepped transmission mode that changes the transmission ratio in stepped fashion, simulating stepped transmission, the transmission control method comprising:
selecting the pseudo stepped transmission mode when pseudo stepped transmission start condition is established, and performing pseudo stepped upshift which repeats a transmission ratio suppression phase in which changes in the transmission ratio of the continuously variable transmission are suppressed, and an upshift phase in which the transmission ratio of the continuously variable transmission is upshifted; and
when performing the pseudo stepped upshift, determining an acceleration intention based on an accelerator opening degree and a vehicle speed, and setting upshift time required to pass through the upshift phase so that the greater the acceleration intention, the shorter that the upshift time, and so that, for the same accelerator opening degree, the higher the vehicle speed, the shorter the upshift time.
